(19) United States
(12) Patent Application Publication
(10) Pub. No.: US 2024/0154336 A1
(43) Pub. Date: May 9, 2024

(54) PLUG-IN TERMINAL

(71) Applicant: Changchun Jetty Automotive Technology Co., Ltd., Changchun (CN)

(72) Inventors: Chao WANG, Changchun (CN); Zijian WANG, Changchun (CN)

(73) Assignee: Changchun Jetty Automotive Technology Co., Ltd., Changchun (CN)

(21) Appl. No.: 18/413,060

(22) Filed: Jan. 16, 2024

Related U.S. Application Data
(63) Continuation-in-part of application No. PCT/CN2022/106038, filed on Jul. 15, 2022.

(30) Foreign Application Priority Data
Jul. 15, 2021 (CN) 202110803170.3
Jul. 15, 2021 (CN) 202121611139.1

(51) Int. Cl. H01R 13/11; H01R 13/03

(52) U.S. Cl. CPC H01R 13/11; H01R 13/03

(57) ABSTRACT

A plug-in terminal, including a connection unit and an elastic unit that are arranged and connected to each other in an axial direction of the plug-in terminal. The elastic unit includes a plurality of elastic sheets arranged at intervals in a circumferential direction of the plug-in terminal. One ends of the plurality of elastic sheets away from the connection unit form a free end of the elastic unit. The plurality of elastic sheets enclose a cavity for receiving a mating terminal inserted from the free end. The plug-in terminal further includes conductive wear-resistant layers located in the cavity and fixed to inner walls of the elastic sheets, respectively. The conductive wear-resistant layers protrude from inner wall surfaces of the elastic sheets respectively for being in contact with an outer wall of the mating terminal.

### RELATED APPLICATION

The present application is a continuation-in-part of International Application No. PCT/CN2022/106038, filed on Jul. 15, 2022, which claims to priority to Chinese Invention Patent Application No. 202110803170.3 filed on Jul. 15, 2021, and Chinese Utility Model Patent No. 202121611139.1 filed on Jul. 15, 2021, all of which are hereby incorporated by reference in their entireties.

### TECHNICAL FIELD

The present application relates to the field of electrical connection, in particular to a plug-in terminal.

### BACKGROUND

The plug-in terminal needs to be plugged with the mating terminal when in use. Frequent plugging and unplugging actions will lead to wear of the plug-in terminal, which not only reduces service life of the plug-in terminal, but also causes poor contact of the plug-in terminal, affects normal use of the plug-in terminal, and even causes a safety accident in serious cases.

### SUMMARY

An object of the present application is to provide an elastic plug-in terminal to solve the problem that the existing plug-in terminal is easily to be worn.

To achieve the above object, the present application provides a plug-in terminal including a connection unit and an elastic unit that are arranged and connected to each other in an axial direction of the plug-in terminal. The elastic unit includes a plurality of elastic sheets arranged at intervals in a circumferential direction of the plug-in terminal. One ends of the plurality of elastic sheets away from the connection unit form a free end of the elastic unit, and the plurality of elastic sheets enclose a cavity for receiving a mating terminal inserted from the free end. The plug-in terminal further includes conductive wear-resistant layers located in the cavity and fixed to inner walls of the elastic sheets, respectively. The conductive wear-resistant layers protrude from inner wall surfaces of the elastic sheets respectively for being in contact with an outer wall of the mating terminal.

The plug-in terminal of the present application has the following characteristics and advantages:

1. According to the present application, electric sheets are provided to make the elastic unit have elasticity and be able to be in close contact with the mating terminal, so as to guarantee more contact area and achieve better electric property and mechanical property; the conductive wear-resistant layers are provided to, on one hand, play a wear-resistant effect and prevent the inner wall of the elastic sheet from being worn and prolong the service life of the plug-in terminal, and on the other hand, play a conductive role by electrically connecting the elastic sheet with the mating terminal.

2. According to the present application, a plurality of conductive wear-resistant layers may be provided on each elastic sheet, so that each elastic sheet is in contact with the outer wall of the mating terminal through the plurality of conductive wear-resistant layers, which not only increases the contact area between the plug-in terminal and the mating terminal, but also improves the wear resistance.

3. According to the present application, a scraping protrusion may be provided on the inner wall of each elastic sheet, so that when the mating terminal is inserted into the plug-in terminal, the scraping protrusion first comes into contact with the mating terminal to scrap the debris from the mating terminal to prevent the debris on the mating terminal from being caught between the conductive wear-resistant layer and the mating terminal, thereby ensuring good electrical contact between the conductive wear-resistant layer and the mating terminal.

4. According to the present application, a curved groove may be provided on the outer wall of each elastic sheet to eliminate the external stress of the elastic sheet, so that the elastic sheet maintains good elasticity after being repeatedly deformed and repeatedly heated, thereby making the elastic sheet not easy to be permanently deformed.

5. According to the present application, a spiral projection and/or a plurality of convex points may be provided on the inner wall surface of each elastic sheet, so as to increase the pressure between the elastic sheets and the mating terminal that are plugged with each other, thereby effectively reducing the contact resistance and reducing the risk of fire caused by temperature rise.

### BRIEF DESCRIPTION OF DRAWINGS

The drawings illustrated here are intended to provide a further understanding of the present invention, and constitute a part of the present application rather than limitations thereto. In the drawings:

FIG. 1 is a structural schematic diagram of an appearance of a plug-in terminal according to a first embodiment of the present application;

FIG. 2 is a cross-sectional view of the plug-in terminal as shown in FIG. 1;

FIG. 3 is a cross-sectional view of a plug-in terminal according to a second embodiment of the present application;

FIG. 4 is a cross-sectional view of a plug-in terminal according to a third embodiment of the present application;

FIG. 5 is a cross-sectional view of a plug-in terminal according to a fourth embodiment of the present application.

FIG. 6 is a cross-sectional view of a plug-in terminal according to a fifth embodiment of the present application.

FIG. 7 is a cross-sectional view of a plug-in terminal according to a sixth embodiment of the present application.

### DETAILED DESCRIPTION OF EMBODIMENTS

For a clearer understanding of the objectives, technical features and effects of the embodiments of the present disclosure, specific embodiments will now be described with reference to the drawings. The described embodiments are intended only to schematically illustrate and explain this invention and do not limit the scope of the present disclosure.

In the description of the present application, “a plurality of” means two or more, unless otherwise indicated. In the description of the present application, unless otherwise stated, the term “connection” is to be understood in a broad sense, for example, it may be fixed connection, detachable connection, direct connection or indirect connection through an intermediate medium, and the specific meaning of the term in the present application can be understood by a person skilled in the art according to specific circumstances.

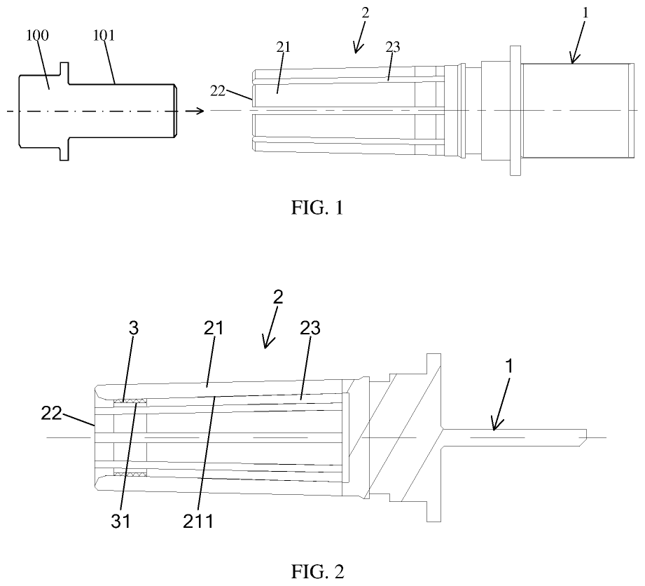

As shown in FIGS. 1 and 2, the present application provides a plug-in terminal including a connection unit 1 and an elastic unit 2 that are arranged and connected to each other in an axial direction of the plug-in terminal. The elastic unit 2 includes a plurality of elastic sheets 21 arranged at intervals in a circumferential direction of the plug-in terminal. One ends of the plurality of elastic sheets 21 away from the connection unit 1 form a free end 22 of the elastic unit 2, and the plurality of elastic sheets 21 enclose a cavity for receiving a mating terminal 100 inserted from the free end 22. The plug-in terminal further includes conductive wear-resistant layers 3 located in the cavity and fixed to inner walls of the elastic sheets 21, respectively. The conductive wear-resistant layers 3 protrude from inner wall surfaces 211 of the elastic sheets 21 respectively for being in contact with an outer wall 101 of the mating terminal 100.

In the present application, electric sheets 21 are provided to make the elastic unit 2 have elasticity and be able to be in close contact with the mating terminal, so as to guarantee more contact area and achieve better electric property and mechanical property. The conductive wear-resistant layers 3 are provided to, on one hand, play a wear-resistant effect and prevent the inner wall of the elastic sheet 21 from being worn and prolong the service life of the plug-in terminal, and on the other hand, play a conductive role by electrically connecting the elastic sheet 21 with the mating terminal.

As shown in FIG. 2, in an embodiment, the conductive wear-resistant layers 3 on the plurality of elastic sheets 21 are sequentially aligned in the circumferential direction of the plug-in terminal. That is, the conductive wear-resistant layers 3 on the plurality of elastic sheets 21 constitute a wear-resistant ring that extends discontinuously in the circumferential direction of the plug-in terminal. The conductive wear-resistant layers 3 are arranged adjacent to the free end 22 to prevent the mating terminal from rubbing against the free end of the elastic sheet 21 when the mating terminal is being inserted into the cavity.

Further, both ends of the conductive wear-resistant layer 3 in the axial direction are chamfered or radiused to facilitate the insertion of the mating terminal.

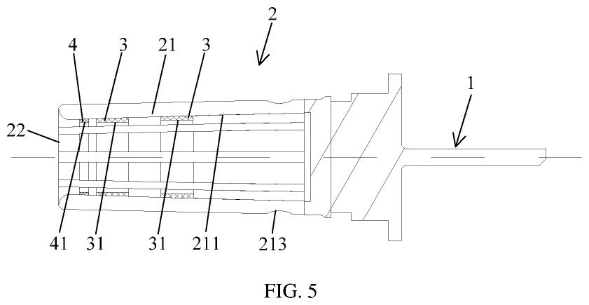

As shown in FIG. 5, in an embodiment, each elastic sheet 21 is provided with a plurality of conductive wear-resistant layers 3 that are arranged at intervals in a length direction of the elastic sheet. Each elastic sheet 21 is in contact with the outer wall of the mating terminal through the plurality of conductive wear-resistant layers 3, which not only increases the contact area between the plug-in terminal and the mating terminal, but also improves the wear resistance.

In an embodiment, as shown in FIG. 2, an entirety of the conductive wear-resistant layer 3 protrudes from the inner wall surface 211 of the elastic sheet 21. Specifically, the inner wall surface of the elastic sheet 21 is smooth, and the conductive wear-resistant layer 3 is fixed on the inner wall surface of the elastic sheet 21, and the overall protruding height of the conductive wear-resistant layer 3 is 0.5 μm to 70 μm.

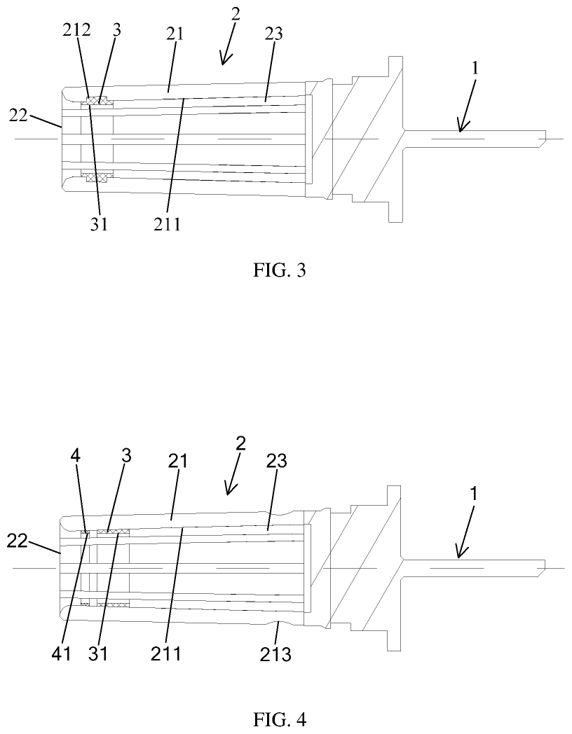

In another embodiment, as shown in FIG. 3, the inner wall surface 211 of each elastic sheet 21 is provided with a concave embedding groove 212. Part of the conductive wear-resistant layer 3 is fixed to and embedded into the embedding groove 212, the other part of the conductive wear-resistant layer 3 protrudes from the inner wall surface 211 of the elastic sheet 21, and the overall protruding height of the conductive wear-resistant layer 3 is 0.5 μm to 70 μm.

However, the present application is not limited to the above embodiments, the conductive wear-resistant layer 3 can also be fixed on the inner wall surface of the elastic sheet 21 by other means.

In order to test the influence of the overall protruding height of the conductive wear-resistant layer 3 on the wear and electric conductivity of the conductive wear-resistant layer 3, the inventor selects ten groups of terminals with different protruding heights for testing, and tests the number of times of plugging and unplugging as well as electric conductivity of the terminals when the conductive wear-resistant layer 3 is worn. The test results are shown in Table 1.

The numbers of times of plugging and unplugging in Table 1 are obtained as follows: the plug-in terminals are fixed on an experiment platform respectively; a mechanical device is used to simulate the plugging and unplugging of the plug-in terminal with the mating terminal; and after every 100 times of plugging and unplugging, stop plugging and unplugging and observe the damage of the conductive wear-resistant layer 3 of the terminal. When the conductive wear-resistant layer 3 of the terminal is scratched and the material of the terminal itself is exposed, the experiment is stopped and the number of times of plugging and unplugging at that time is recorded. In this embodiment, if the number of times of plugging and unplugging is less than 8000, it is considered as unqualified.

The electric conductivity in Table 1 is obtained as follows: the plug-in terminals are plugged with the mating terminal, then the plugged terminals are conducted current, and then the electric conductivity at the plugging position where the terminals are plugged with each other is detected. In this embodiment, if the electrical conductivity is greater than 99%, it is considered as qualified.

The test results are shown in Table 1.

TABLE 1
Influence of Different Protruding Heights of the Conductive wear-resistant layers 3 on the
Number of Times of Plugging and Unplugging as well as Electric Conductivity of the Plug-in Terminal
Protruding Heights (μm) of the Conductive wear-resistant layers 3

| | | | | | | | | | | |
|---|---|---|---|---|---|---|---|---|---|---|
| 0.2 | 0.4 | 0.5 | 2 | 12 | 25 | 35 | 45 | 60 | 70 | 75 |

Number of Times of Plugging and Unplugging of the Plug-in Terminal

| | | | | | | | | | | |
|---|---|---|---|---|---|---|---|---|---|---|
| 7600 | 7800 | 8300 | 8500 | 8900 | 9300 | 9600 | 9800 | 11200 | 11600 | 12100 |

Electric Conductivity (%) of the Plug-in Terminal

| | | | | | | | | | | |
|---|---|---|---|---|---|---|---|---|---|---|
| 99.8 | 99.8 | 99.7 | 99.7 | 99.6 | 99.6 | 99.5 | 99.4 | 99.2 | 99.1 | 98.5 |

As can be seen from Table 1, when the height of the conductive wear-resistant layer 3 of the terminal is less than 0.5 the electric conductivity of the plugged terminals is qualified, but the number of times of plugging and unplugging of the plug-in terminal do not meet the requirement, which means that the conductive wear-resistant layer 3 of the terminal is easily worn and cannot meet the service life requirement of the plug-in terminal. When the height of the conductive wear-resistant layer 3 of the terminal is greater than 70 although the number of times of plugging and unplugging of the plug-in terminal is qualified, the contact resistance is increased due to the height of the conductive wear-resistant layer 3 of the terminal being too high, resulting in the electric conductivity of the plugged terminals not meeting the requirement, and the electrical performance of the plugged terminals being poor. Therefore, the inventor selects the value of the protruding height of the conductive wear-resistant layer 3 to be 0.5 μm to 70 μm, which can not only meet the requirement of the number of times of plugging and unplugging of the plug-in terminal, but also meet the requirement of the electric conductivity of the plug-in terminal, thereby greatly improving the electrical performance of the plugged terminals and prolonging the service life of the electrical device.

In an embodiment, the inner surface 31 of the conductive wear-resistant layer 3 is an arc surface that can be fitted with the outer wall surface of the mating terminal, so as to increase the contact area between the conductive wear-resistant layer and the mating terminal. The plug-in terminal and the mating terminal generally have circular cross sections. If the inner wall of the plug-in terminal cannot be completely fitted with the outer wall surface of the mating terminal during the use of the plug-in terminal, it will lead to poor contact of the plug-in terminal and lead to increase of the contact resistance, which may further lead to a fire due to high temperature of the plug-in terminal in work. In the present application, the inner surface 31 of the conductive wear-resistant layer 3 may be set as an arc surface that can be fitted with the outer wall surface of the mating terminal, thereby increasing the contact area between the conductive wear-resistant layer and the mating terminal, effectively reducing the contact resistance and reducing the risk of fire caused by temperature rise.

In order to increase the contact area between the elastic sheet 21 and the mating terminal, the following three embodiments are provided.

In a first embodiment, as shown in FIG. 7, the inner wall surfaces 211 of the elastic sheets 21 are provided with a spiral projection 214 for being in contact with the mating terminal. The spiral projection 214 can increase the pressure between the plug-in terminal and the mating terminal that are plugged with each other, thus effectively reducing the contact resistance and reducing the risk of fire caused by temperature rise. The spiral projection 214 is made of electrically conductive material. As the plurality of the elastic sheets 21 are spaced apart in the circumferential direction, the spiral projection 214 extends discontinuously on the inner wall surfaces 211 of the plurality of the elastic sheets 21.

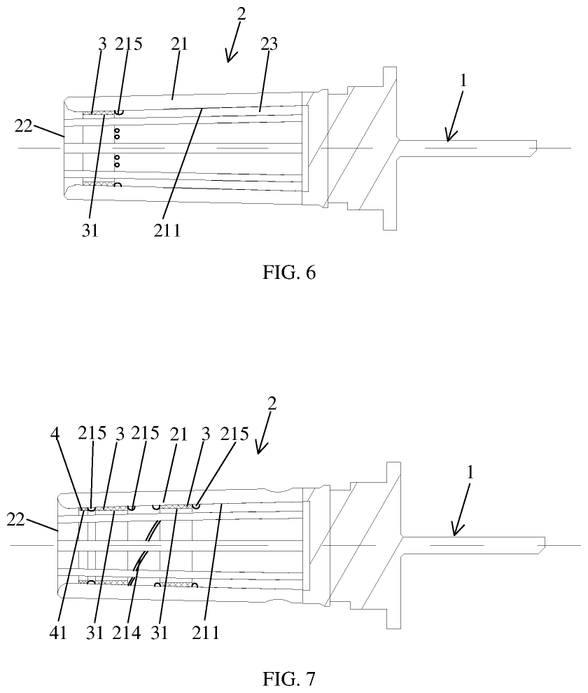

In a second embodiment, as shown in FIGS. 6 and 7, the inner wall surfaces 211 of the elastic sheets 21 are provided with a plurality of convex points 215 for being in contact with the mating terminal. The convex points 215 can increase the pressure between the plug-in terminal and the mating terminal that are plugged with each other, thus effectively reducing the contact resistance and reducing the risk of fire caused by temperature rise. The convex points 215 are made of electrically conductive material. The surface of each convex points 215 may be concave-arc shaped.

In a third embodiment, as shown in FIG. 7, the inner wall surfaces 211 of the elastic sheets 21 are provided with a spiral projection 214 and a plurality of convex points 215 for being in contact with the mating terminal. By providing both the spiral projection and the plurality of convex points, the contact area between the elastic sheets 21 and the mating terminal can be further increased, and the pressure between the plug-in terminal and the mating terminal that are plugged with each other can be further increased, thus effectively reducing the contact resistance and reducing the risk of fire caused by temperature rise. The spiral projection 214 and the convex points 215 are made the same or different electrically conductive materials, respectively.

Optionally, the spiral projection 214 and/or the convex points 215 are provided adjacent to the conductive wear-resistant layers 3. In other words, the spiral projection 214 and/or the convex points 215 fill a gap between the inner wall surfaces 211 of the elastic sheets 21 and the outer wall surface of the mating terminal that is inserted into the plug-in terminal. Specifically, since the conductive wear-resistant layers 3 protrude from inner wall surfaces 211, when the mating terminal is inserted into the cavity inside the elastic sheets 21, the gap adjacent to the conductive wear-resistant layers 3 may be formed. Therefore, the spiral projection 214 and/or the convex points 215 may be provided to fill the gap and be in contact with the outer surface of the mating terminal, thereby increasing the contact area between the elastic sheet 21 and the mating terminal.

In order to improve the simplicity of the accompanying drawings, only part of the spiral projection 214 and a small number of convex points 215 are shown schematically in the drawings. It should be appreciated that the positions, the numbers and the sizes of the spiral projection 214 and the convex points 215 illustrated in the figures are schematic and do not limit the present disclosure. The positions, the numbers and the sizes of the spiral projection 214 and the convex points 215 may be set according to actual needs, as long as they are capable of filling the gap between the inner wall surfaces 211 of the elastic sheets 21 and the outer wall surface of the mating terminal.

Optionally, the spiral projection 214 and the convex points 215 are made of the same material as the elastic sheets 21.

Optionally, the spiral projection 214 has a height substantially equal to or less than that of the conductive wear-resistant layer 3, and/or each convex point 215 has a height substantially equal to or less than that of the conductive wear-resistant layer 3. The height of the spiral projection 214 may be the same or different from that of the convex points 215. The heights of different convex points 215 may be the same or different.

In an embodiment, the conductive wear-resistant layer 3 includes a bottom layer and a surface layer. The bottom layer is made of one or more selected from the group consisting of gold, silver, nickel, tin, tin-lead alloy and zinc. The surface layer is made of one or more selected from the group consisting of gold, silver, nickel, tin, tin-lead alloy, silver-antimony alloy, palladium, palladium-nickel alloy, graphite-silver, graphene-silver and silver-gold-zirconium alloy.

The conductive wear-resistant layer 3 is made of one or more selected from the group consisting of gold, silver, nickel, tin, zinc, tin-lead alloy, silver-antimony alloy, palladium, palladium-nickel alloy, graphite-silver, graphene-silver and silver-gold-zirconium alloy. The conductive wear-resistant layer 3, as a metal contact that needs to be plugging and unplugging frequently, should be made of wear-resistant metal, thereby greatly increasing the service life of the metal contact. In addition, the metal contact should have excellent electrical conductivity, and above-mentioned metals have better electrical conductivity and stability than that of copper and copper alloys, thereby making the plug-in terminal obtain better electrical property and longer service life.

In order to demonstrate the influence of different materials of the conductive wear-resistant layer 3 on the overall performance of the plug-in terminal, the inventor adopts plug-in terminal samples and mating terminals to carry out a series of tests on the number of times of plugging and unplugging and the corrosion resistance time. The plug-in terminal samples have the same specification and the same material, and have conductive wear-resistant layers 3 of different materials. The mating terminals have the same specification. The experimental results are shown in Table 2 below.

The numbers of times of plugging and unplugging in Table 2 are obtained as follows: the plug-in terminals are fixed on the experiment platform respectively; a mechanical device is used to simulate the plugging and unplugging of the plug-in terminals; and after every 100 times of plugging and unplugging, stop plugging and unplugging and observe the damage of the conductive wear-resistant layer 3 on the surface of the terminal. When the conductive wear-resistant layer 3 on the surface of the terminal is scratched and the material of the terminal itself is exposed, the experiment is stopped and the number of times of plugging and unplugging at that time is recorded. In this embodiment, if the number of times of plugging and unplugging is less than 8000, it is considered as unqualified.

The electric conductivity in Table 2 is obtained as follows: the plug-in terminals are plugged with the mating terminals, then the plugged terminals are conducted current, and then the electric conductivity at the plugging position where the terminals are plugged with each other is detected. In this embodiment, if the electrical conductivity is greater than 99%, it is considered as qualified.

TABLE 2
Influence of Different Materials of the Conductive wear-resistant layers 3 on the Number of Times
of Plugging and Unplugging as well as Electric Conductivity of the Plug-in Terminal
Different materials of the conductive wear-resistant layers

| | | | | | | | | | | | |
|---|---|---|---|---|---|---|---|---|---|---|---|
| | | | | | Silver- | | | | | | |
| | | | | | gold- | | | | | | |
| | | Silver- | | | zircon- | | | | Palladium- | Tin- | |
| | | antimony | Graphite- | Graphene- | ium | | | Palla- | nickel | lead | |
| Gold | Silver | Alloy | silver | silver | Alloy | Tin | Nickel | dium | Alloy | Alloy | Zinc |

Number of Times of Plugging and Unplugging (times)

| | | | | | | | | | | | |
|---|---|---|---|---|---|---|---|---|---|---|---|
| 12000 | 11400 | 12100 | 12500 | 12800 | 13100 | 8200 | 8300 | 11000 | 1200 | 9800 | 8500 |

Number of Corrosion Resistance Test Cycles (times)

| | | | | | | | | | | | |
|---|---|---|---|---|---|---|---|---|---|---|---|
| 99.9 | 99.9 | 99.9 | 99.9 | 99.9 | 99.9 | 99.6 | 99.7 | 99.8 | 99.8 | 99.6 | 99.4 |

As can be seen from Table 2 above, when the material of the conductive wear-resistant layer 3 is selected from gold, silver, silver-antimony alloy, palladium, palladium-nickel alloy, graphite-silver, graphene-silver and silver-gold-zirconium alloy, the experimental results are much greater than the standard value, and the performance is relatively stable. When the material of the conductive wear-resistant layer 3 is selected from nickel, tin, tin-lead alloy and zinc, the experimental results can also meet the requirement. Therefore, the inventor selects the material of the conductive wear-resistant layer 3 as one or more selected from the group consisting of gold, silver, nickel, tin, zinc, tin-lead alloy, silver-antimony alloy, palladium, palladium-nickel alloy, graphite-silver, graphene-silver and silver-gold-zirconium alloy.

The thickness of the conductive wear-resistant layer has a great influence on both the overall performance and service life of the plug-in terminal, and may cause the service life of the product to decrease sharply or even failure of the product in serious cases. If the thickness of the conductive wear-resistant layer is too small, the wear-resisting property of the plug-in terminal does not meet the requirement. If the thickness of the conductive wear-resistant layer is too large, the conductive wear-resistant layer is easy to fall off the terminal surface of the terminal, resulting in a decrease in the wear-resistant property, a decrease in the contact area between the plug-in terminal and the mating terminal, and an increase in the contact resistance, which may cause risks such as fire due to temperature rise. Moreover, since the material of the conductive wear-resistant layer 3 is expensive metal, if the conductive wear-resistant layer 3 has a great thickness but fails to improve performance, it is not valuable for use.

In order to demonstrate the influence of the thickness of the bottom layer of the conductive wear-resistant layer 3 on the overall performance of the plug-in terminal, the inventor adopts plug-in terminal samples and mating terminals to carry out a series of tests on temperature rise and the number of times of plugging and unplugging. The plug-in terminal samples have the same specifications and the same material, have nickel bottom layers of different thicknesses and have silver surface layers of the same thickness. The mating terminals have the same specification. The experimental results are shown in Table 3 below.

The test on temperature rises in Table 3 is to supply the same current to the plug-in terminals and the mating terminals that are respectively plugged with each other, detect the temperatures of the plug-in terminals at the same position before the current supply and after the temperature is stable in a closed environment, and take a difference therebetween to obtain an absolute value. In this embodiment, if the temperature rise is greater than 50K, it is considered as unqualified.

The test on the numbers of times of plugging and unplugging in Table 3 is to fix the plug-in terminals on the experiment platform respectively, use a mechanical device to simulate the plugging and unplugging of the plug-in terminals, and after every 100 times of plugging and unplugging, stop plugging and unplugging and observe the damage of the conductive wear-resistant layer 3 on the surface of the terminal. When the conductive wear-resistant layer 3 of the terminal surface is scratched and the material of the terminal itself is exposed, the experiment is stopped and the number of times of plugging and unplugging at that time is recorded. In this embodiment, if the number of times of plugging and unplugging is less than 8000, it is considered as unqualified.

TABLE 3
Influence of Different Thicknesses of Bottom Layers of Conductive wear-resistant layers 3 on
Temperature Rise and Number of Times of Plugging and Unplugging of the Plug-in Terminal
Different Thicknesses of Nickel Bottom Layer

| | | | | | | | | | | | | | | | |
|---|---|---|---|---|---|---|---|---|---|---|---|---|---|---|---|
| 0.001 | 0.005 | 0.01 | 0.05 | 0.1 | 0.5 | 1 | 3 | 5 | 6 | 9 | 11 | 13 | 15 | 17 | 19 |

Temperature Rise of Plug-in Terminal (k)

| | | | | | | | | | | | | | | | |
|---|---|---|---|---|---|---|---|---|---|---|---|---|---|---|---|
| 10.7 | 12.3 | 14.9 | 16.6 | 18.2 | 21.6 | 24.5 | 26.7 | 28.6 | 31.1 | 35.7 | 40.6 | 43.5 | 47.8 | 58.1 | 67.4 |

Number of Times of Plugging and Unplugging

| | | | | | | | | | | | | | | | |
|---|---|---|---|---|---|---|---|---|---|---|---|---|---|---|---|
| 7500 | 7800 | 8200 | 8500 | 8600 | 8800 | 9000 | 9200 | 9500 | 9700 | 10000 | 10200 | 10500 | 10800 | 10900 | 11000 |

As can be seen from Table 3 above, when the thickness of the nickel bottom layer is smaller than 0.01 μm, although the temperature rise of the plug-in terminal is qualified, the number of times of plugging and unplugging of the plug-in terminal is smaller than the qualified value due to the conductive wear-resistant layer being too thin, which does not meet the required performance of the plug-in terminal, has a negative impact on both the overall performance and service life of the plug-in terminal, and may cause the service life of the product to decrease sharply or even failure of the product and combustion accidents in serious cases. When the thickness of the nickel bottom layer is greater than 15 μm, the heat generated by the plug-in terminal cannot be radiated due to the bottom layer of the conductive wear-resistant layer 3 being too thick, which makes the temperature rise of the plug-in terminal unqualified, and in addition, the thick bottom layer is easy to fall off the surface of the terminal, resulting in a decrease in the number of cycles of corrosion resistance. Therefore, the inventor selects the thickness of the bottom layer of the conductive wear-resistant layer 3 to be 0.01 μm to 15 μm. Exemplarily, the inventor finds that when the thickness of the bottom layer of the conductive wear-resistant layer 3 is 0.1 μm to 9 μm, the combined effect of the temperature rise and the number of times of plugging and unplugging of the plug-in terminal is better. Therefore, in order to further improve the safety, reliability and practicality of the plug-in terminal, the thickness of the bottom layer of the conductive wear-resistant layer 3 is exemplarily 0.1 μm to

In order to demonstrate the influence of the thickness of the surface layer of the conductive wear-resistant layer 3 on the overall performance of the plug-in terminal, the inventor adopts plug-in terminal samples and mating terminals to carry out a series of tests on the temperature rise and the number of times of plugging and unplugging. The plug-in terminal samples have the same specification and the same material, have nickel bottom layers of the same thickness and have silver surface layers of different thicknesses. The mating terminals have the same specification. The experimental results are shown in Table 4 below.

The experimental method is the same as above.

TABLE 4
Influence of Different Thicknesses of the Surface Layers of Conductive wear-resistant layers 3 on
Temperature Rise and Number of Times of Plugging and Unplugging
Different Thicknesses of the Surface Layers of Conductive wear-resistant layers 3 (μm)

| | | | | | | | | | | | | | | | | |
|---|---|---|---|---|---|---|---|---|---|---|---|---|---|---|---|---|
| 0.1 | 0.5 | 1 | 1.5 | 5 | 10 | 15 | 20 | 25 | 30 | 35 | 40 | 45 | 50 | 55 | 60 | 65 |

Tempature Rise of Plug-in Terminal (k)

| | | | | | | | | | | | | | | | | |
|---|---|---|---|---|---|---|---|---|---|---|---|---|---|---|---|---|
| 11.4 | 13.8 | 15.2 | 17.5 | 21.8 | 23.9 | 25.3 | 28.6 | 31.8 | 35.4 | 38.9 | 42.7 | 45.3 | 48.4 | 49.5 | 53.8 | 69.6 |

Number of Times of Plugging and Unplugging

| | | | | | | | | | | | | | | | | |
|---|---|---|---|---|---|---|---|---|---|---|---|---|---|---|---|---|
| 7500 | 8100 | 8300 | 8400 | 8800 | 9100 | 9400 | 9800 | 10200 | 10500 | 10800 | 10900 | 11000 | 11100 | 11200 | 11300 | 11400 |

As can be seen from Table 4 above, when the thickness of the silver surface layer is smaller than 0.5 μm, although the temperature rise of the plug-in terminal is qualified, the number of times of plugging and unplugging of the plug-in terminal is smaller than the qualified value due to the conductive wear-resistant layer being too thin, which does not meet the required performance of the plug-in terminal, has a negative impact on both the overall performance and service life of the plug-in terminal, and may cause the service life of the product to decrease sharply or even failure of the product and combustion accidents in serious cases. When the thickness of the silver surface layer is greater than 55 μm, the heat generated by the plug-in terminal cannot be radiated due to the surface layer of the conductive wear-resistant layer 3 being too thick, which makes the temperature rise of the plug-in terminal unqualified, and in addition, the thick conductive wear-resistant layer 3 is easy to fall off the surface of the terminal, resulting in a decrease in the number of cycles of corrosion resistance. Moreover, since the material of the surface layer of the conductive wear-resistant layer 3 is expensive metal, if the conductive wear-resistant layer 3 has a great thickness but fails to improve performance, it is not valuable for use. Therefore, the inventor selects the thickness of the surface layer of the conductive wear-resistant layer 3 to be 0.1 μm to 55 μm.

Exemplarily, the inventor finds that when the thickness of the surface layer of the conductive wear-resistant layer 3 is 1 μm to 35 μm, the combined effect of the temperature rise and the number of times of plugging and unplugging of the plug-in terminal is better. Therefore, in order to further improve the safety, reliability and practicality of the plug-in terminal, the thickness of the surface layer of the conductive wear layer 3 is exemplarily 1 μm to 35 μm.

In an embodiment, the inner wall of each elastic sheet 21 is provided with a plurality of conductive wear-resistant layers 3 that are arranged at intervals in an axial direction of the plug-in terminal. In other words, a plurality of conductive wear-resistant layers are arranged on each elastic sheet, and each elastic sheet is in contact with the outer wall of the mating terminal through the plurality of conductive wear-resistant layers, which not only increases the contact area between the plug-in terminal and the mating terminal, but also improves the wear resistance.

Optionally, as shown in FIG. 7, the spiral projection 214 and/or the convex points 215 may be provided between the plurality of conductive wear-resistant layers 3.

In an embodiment, the inner diameter of the cavity of the plug-in terminal is gradually decreased in the axial direction towards the free end 22. That is, the cavity has the smallest inner diameter at an end of the cavity where the free end 22 of the plug-in terminal is located, which not only allows the mating terminal to be inserted into the cavity, but also allows the elastic sheet to have a larger deformation space, such that the elastic unit 2 and the mating terminal have a greater gripping force after being plugged with each other.

As shown in FIGS. 1 to 4, in an embodiment, an expandable and contractible seam 23 is formed between any two adjacent elastic sheets 21. The width of each expandable and contractible seam 23 is gradually decreased in the axial direction towards the free end 22. That is, the width of an end of the expandable and contractible seam 23 has the smallest width at an end of the seam 23 where the free end 22 of the plug-in terminal is located, which makes the width of the front end of the elastic sheet 21 larger than the width of the rear end thereof, allowing for a conductive wear-resistant layer 3 with a large width to be provided on the front end of the elastic sheet 21 to increase the contact area between the conductive wear-resistant layer 3 and the mating terminal. In addition, since the width of the rear end of the expandable and contractible seam 23 is larger than the width of the front end thereof, a good sediment discharge and water drainage performance can be obtained.

In an embodiment, the number of elastic sheets 21 is an even number so that the elastic sheets 21 are symmetrically disposed to ensure symmetrical distribution of stress between the elastic sheets 21 and the mating terminal that is in contact with the elastic sheets 21. For example, the number of elastic sheets 21 is 4, 6, 8, 10, 12, 14, or 16.

In an embodiment, as shown in FIG. 4, the plug-in terminal further includes scraping protrusions 4 located in a cavity and fixed to the inner walls of the elastic sheets 21, respectively. In the axial direction of the plug-in terminal, the scraping protrusions 4 are located between the conductive wear-resistant layers 3 and the free end 22. Therefore, when the mating terminal is inserted into the plug-in terminal, the scraping protrusions 4 first come into contact with the mating terminal to scrap the debris from the mating terminal to prevent the debris on the mating terminal from being caught between the conductive wear-resistant layers 3 and the mating terminal, thereby ensuring good electrical contact between the conductive wear-resistant layers 3 and the mating terminal.

In a feasible technical solution, the inner surfaces 41 of the scraping protrusions 4 do not protrude beyond the inner surfaces 31 of the conductive wear-resistant layers 3 to prevent the scraping protrusions 4 from hampering the contact between the conductive wear-resistant layers 3 and the mating terminal.

In another feasible technical solution, the inner surfaces 41 of the scraping protrusions 4 on the plurality of the elastic sheets 21 and the inner surfaces 31 of the conductive wear-resistant layers 3 are all located on the same circular ring surface or the same circular conical surface, so that the scraping protrusions 4 do not hamper the contact between the conductive wear-resistant layers and the mating terminal, and meanwhile can support the mating terminal.

Optionally, as shown in FIG. 7, the spiral projection 214 and/or the convex points 215 may be provided between the conductive wear-resistant layers 3 and the scraping protrusions 4.

Further, an end of each scraping protrusion 4 close to the free end 22 is provided with a chamfered corner or a radiused corner to facilitate the insertion of the mating terminal.

As shown in FIG. 4, in an embodiment, the outer wall of the other end of each elastic sheet 21 that is close to the connection unit 1 is provided with a curved groove 213, and the curved grooves 213 on the plurality of elastic sheets 21 form an annular groove that extends discontinuously in the circumferential direction of the plug-in terminal. By providing the curved grooves 213, the external stress of the elastic sheets 21 can be eliminated, such that the elastic sheets 21 maintains good elasticity after being repeatedly deformed and repeatedly heated, thereby making the elastic sheets not easy to be permanently deformed.

Further, the depth of the curved groove 213 is not greater than one third of the thickness of the elastic sheet 21, which can not only eliminate the external stress of the elastic sheet 21, but also avoid inadequate strength of the elastic sheet 21 due to too small thickness thereof.

In an embodiment, the connection unit 1 is made of aluminum or aluminum alloy, to facilitate connection with an aluminum wire or other aluminum conductors.

In an embodiment, the elastic unit 2 is made of copper or copper alloy, to facilitate connection with a copper wire or other copper conductors.

Due to high voltage and high current, electric vehicle cables need to use large-diameter copper conductors for current conduction. However, with the rising price of copper, the cost for using copper as the material of the conductors will become higher and higher. For this reason, people are looking for alternatives to the copper to reduce costs. The content of aluminium in the earth's crust is about 7.73%, and the price of the aluminium is relatively low due to the optimization of refining technology. In addition, compared with copper, aluminum is light in weight and is second only to copper in conductivity. Therefore, aluminum can replace some copper in the field of electrical connection, and it is a developing trend to replace copper with aluminum in electrical connection of automotive field.

However, the electrode potential difference between copper and aluminum is large, if copper and aluminum wires are connected directly, electrochemical corrosion may occur between copper and aluminum wires, and aluminum is susceptible to corrosion, resulting in increased resistance in the connection area, which may easily cause serious consequences in the electrical connection, such as functional failure, fire, etc.

In order to solve the problem in prior art that copper and aluminum wires are difficult to connect reliably, in some embodiments, the material of the connection unit 1 is aluminum or aluminum alloy, and the material of the elastic unit 2 is copper or copper alloy, so as to realize reliable connection between the copper and aluminum wires and solve the problem that the copper and aluminum wires are difficult to be reliably connected to each other.

Further, the connection unit 1 and the elastic unit 2 are connected to each other by one or more selected from friction welding, ultrasonic welding, arc welding, laser welding and resistance welding.

The friction welding refers to a method of welding by using the heat generated by the friction between the contact surfaces of the workpieces as the heat source to make the workpieces be plastically deformed under pressure.

The ultrasonic welding is to transmit high-frequency vibration waves to the surfaces of two to-be-welded objects, so that the surfaces of the two objects rub against each other under pressure to form a fuse molecular layer.

The arc welding is to convert electric energy into heat energy and mechanical energy needed for welding by using electric arc as a heat source and using the physical phenomenon of air discharge, so as to connect metals. The arc welding mainly includes shielded metal arc welding, submerged arc welding and gas shielded welding, etc.

The laser welding is an efficient and precise welding method using a laser beam of a high energy density as a heat source.

The resistance welding refers to a method of welding by passing strong current through a contact point between an electrode and a workpiece to generate heat by a contact resistance.

By adopting the above processing methods or combination thereof, the elastic unit 2 made of copper/copper alloy and the connection unit 1 made of aluminum/aluminum alloy can be connected effectively to ensure that the plug-in terminal has good mechanical and electrical properties.

The above descriptions are only embodiments of the present application and are not intended to limit the application. Various changes and modifications can be made to the present application by those skilled in the art. Any modifications, equivalents, improvements, etc. made within the spirit and scope of the present application are intended to be included within the scope of the claims of the present application.

1. A plug-in terminal comprising a connection unit and an elastic unit that are arranged and connected to each other in an axial direction of the plug-in terminal;
wherein the elastic unit comprises a plurality of elastic sheets arranged at intervals in a circumferential direction of the plug-in terminal, one ends of the plurality of elastic sheets away from the connection unit form a free end of the elastic unit, and the plurality of elastic sheets enclose a cavity for receiving a mating terminal inserted from the free end;
the plug-in terminal further comprises conductive wear-resistant layers located in the cavity and fixed to inner walls of the elastic sheets, respectively; and
the conductive wear-resistant layers protrude from inner wall surfaces of the elastic sheets respectively for being in contact with an outer wall of the mating terminal.

2. The plug-in terminal according to claim 1, wherein the conductive wear-resistant layers on the plurality of elastic sheets are sequentially aligned in the circumferential direction of the plug-in terminal, and the conductive wear-resistant layers are arranged adjacent to the free end.

3. The plug-in terminal according to claim 1, wherein an entirety of the conductive wear-resistant layer protrudes from the inner wall surface of the elastic sheet; or,
the inner wall surface of each elastic sheet is provided with a concave embedding groove, part of the conductive wear-resistant layer is located in the embedding groove, and the other part of the conductive wear-resistant layer protrudes from the inner wall surface of the elastic sheet.

4. The plug-in terminal according to claim 3, wherein the conductive wear-resistant layers protrude at an overall height of 0.5 μm to 70 μm.

5. The plug-in terminal according to claim 1, wherein an inner surface of the conductive wear-resistant layer is an arc surface for being fitted with an outer wall surface of the mating terminal.

6. The plug-in terminal according to claim 1, wherein the inner wall surfaces of the elastic sheets are provided with a spiral projection for being in contact with the mating terminal; and/or
the inner wall surfaces of the elastic sheet are provided with a plurality of convex points for being in contact with the mating terminal.

7. The plug-in terminal according to claim 1, wherein the conductive wear-resistant layer comprises a bottom layer and a surface layer, the bottom layer is made of one or more selected from the group consisting of gold, silver, nickel, tin, tin-lead alloy and zinc, and the surface layer is made of one or more selected from the group consisting of gold, silver, nickel, tin, tin-lead alloy, silver-antimony alloy, palladium, palladium-nickel alloy, graphite-silver, graphene-silver and silver-gold-zirconium alloy.

8. The plug-in terminal according to claim 7, wherein the bottom layer has a thickness of 0.01 μm to 15 μm.

9. The plug-in terminal according to claim 7, wherein the bottom layer has a thickness of 0.1 μm to 9 μm.

10. The plug-in terminal according to claim 7, wherein the surface layer has a thickness of 0.5 μm to 55 μm.

11. The plug-in terminal according to claim 7, wherein the surface layer has a thickness of 1 μm to 35 μm.

12. The plug-in terminal according to claim 1, wherein the inner wall of each elastic sheet is provided with a plurality of conductive wear-resistant layers that are arranged at intervals in the axial direction of the plug-in terminal.

13. The plug-in terminal according to claim 1, wherein an inner diameter of the cavity is gradually decreased in the axial direction toward the free end.

14. The plug-in terminal according to claim 1, wherein the plug-in terminal further comprises scraping protrusions located in the cavity and fixed to the inner walls of the elastic sheets, respectively; and
in the axial direction of the plug-in terminal, the scraping protrusions are located between the conductive wear-resistant layers and the free end.

15. The plug-in terminal according to claim 14, wherein an inner surface of the scraping protrusion does not protrude beyond an inner surface of the conductive wear-resistant layer.

16. The plug-in terminal according to claim 14, wherein inner surfaces of the scraping protrusions on the plurality of elastic sheets and inner surfaces of the conductive wear-resistant layers on the plurality of elastic sheets are all located on the same circular ring surface or the same circular conical surface.

17. The plug-in terminal according to claim 1, wherein an outer wall of the other end of each elastic sheet that is close to the connection unit is provided with a curved groove.

18. The plug-in terminal according to claim 1, wherein the connection unit is made of aluminum or aluminum alloy.

19. The plug-in terminal according to claim 1, wherein the elastic unit is made of copper or copper alloy.
